(19) United States
(12) Patent Application Publication
(10) Pub. No.: US 2016/0071146 A1
(43) Pub. Date: Mar. 10, 2016

(54) SYSTEM AND METHOD FOR DIGITAL ADVERTISING

(71) Applicant: Stephanie Yinman Chan, Saratoga, CA (US)

(72) Inventor: Stephanie Yinman Chan, Saratoga, CA (US)

(21) Appl. No.: 14/478,280

(22) Filed: Sep. 5, 2014

(51) Int. Cl. G06Q 30/02

(52) U.S. Cl. CPC G06Q 30/0248; G06Q 30/0257; G06Q 30/0273

(57) ABSTRACT

This invention relates generally to a method of contextual, digital, and interactive advertisement where a consumer or user is incentivized to participate in order to earn monetary awards. This invention allows the consumer to more thoroughly engage with the subject matter of the primary advertisement, with the effect of supplementing and enhancing the advertising message of the primary advertisement.

### FIELD OF THE INVENTION

The present invention generally relates to a method for advertising. Specifically, this invention relates to an online method for contextual, digital, and interactive advertisement where a consumer or user is incentivized to participate in order to earn monetary awards.

### BACKGROUND OF THE INVENTION

Advertisement is a form of communication where the advertiser conveys a message about its product or service to a user and the user receives the message. Advertisements are most effective when a user is fully receptive of an advertisement message. However, with the inundation of advertisements, many users have adapted to ignore advertisements. Even if the user does not ignore an advertisement, the abundance of advertisements (from television, radio, Internet, product placement, billboards) competing for the user's attention thwart any lasting impression. Accordingly, advertising as a means of marketing becomes an ineffectual exercise in garnering attention of a user.

This is also especially true with online advertisement. An Internet user encounters ads while performing a search inquiry, visiting a social networking site, or while browsing news-based websites. Internet advertising is truly ubiquitous.

Current forms of advertisement, including online advertisement, entail passive participation from the user. Advertisements are designed such that the attention of a user is seized through subject-matter, visual or auditory appeal. For example, when a user is on the Internet, there may be a banner advertisement which displays a vehicle. If the user is interested, he may scroll the mouse pointer over the banner and it may enlarge and display a short video marketing the particular vehicle. However the user may or may not view the entire video. Furthermore, this advertisement may be for one of several vehicles that the user may encounter during a single Internet-use session. Accordingly, this display form of advertisement is inefficient for advertisers. With so many advertisements vying for attention from the user and with the ability of the user to skip viewing of an advertisement, the message of an advertisement is not effectively being communicated to the user.

Therefore, there is a need in the art for a method that distinguishes an advertisement and further instills the message of the advertisement by providing an advertisement experience that delivers more interaction with the advertisement. These and other features and advantages of the present invention will be explained and will become obvious to one skilled in the art through the summary of the invention that follows.

### SUMMARY OF THE INVENTION

Accordingly, it is an object of the present invention to provide a method that induces a user to focus on a particular advertisement and to further engage with the advertisement in order to retain the message the advertisement aims to convey.

According to an embodiment of the present invention, a method and system for digital advertising include: a digital advertising module, which comprises a computer executable code stored in a non-volatile memory, a processor, a communications means, and a display element, where the digital advertising module, the processor, and the communications means are operably connected and are configured to display a logo over an existing digital advertisement over the Internet via the display element, enable a text-based message display when the logo is clicked by a user via a user interface, wherein the text-based message pertains to a content of the existing digital advertisement, present one or more questions based on the content of the text-based message display in the form of a survey or quiz to the user; request the user to select a correct answer among multiple statements provide, permit the user to select an answer via a user interface; and reward the user if all answers were correctly selected.

According to an embodiment of the present invention, a system and method for digital advertising further including a digital advertising module configured to select the existing digital advertisement where the logo is overlaid, to provide a text-based message relevant to the existing digital advertisement; to provide a quiz based on the text-based message, and to process the reward allocation.

According to an embodiment of the present invention, the quiz is randomized to ensure that the user does not receive a duplicate.

According to an embodiment of the present invention, the digital advertisement is operated through a website that offers quizzes s consisting of text-based information pertaining to goods or services. By registering on the website, users can connect to other users and create a network. Through development of the network, a hierarchy of user relationships is established. Individuals in a user's network can earn rewards for themselves as well as other users in the network.

### BRIEF DESCRIPTION OF THE DRAWINGS

FIG. 1 illustrates a schematic overview of a computing device, in accordance with embodiments of the present invention;

FIG. 2 illustrates a schematic overview of a network, in accordance with embodiments of the present invention;

FIG. 3 illustrates a schematic of a system for digital advertising in accordance with embodiments of the present invention;

FIG. 4 illustrates a schematic flow-chart of an exemplary method in accordance with embodiments of the present invention;

FIG. 5 illustrates an embodiment of a mobile phone device employing the method of digital advertising;

FIG. 6 illustrates an embodiment of a mobile phone device employing the method of digital advertising; and

FIG. 7 illustrates an embodiment of a mobile phone device employing the method of digital advertising.

### DETAILED SPECIFICATION

The present invention provides an advertising method and system for the Internet in which brand awareness is raised through an interactive game that incentivizes users to participate by offering rewards. The premise of the game is to inform users about a specific brand, ask the users questions based on the information provided, and reward users if the questions are correctly answered.

The ideology behind the interactive game is based on the rule of three. The rule of three states a grouping of objects/things into threes is an effective means of engaging the audience. Based on this principle a premise of the interactive game is that users are asked three key questions based on a product. Answers to the questions and subject-matter of the questions create a lasting impression on the users. The impression increases brand awareness and ultimately, the brand name itself gains notoriety. The ideal outcome is that the brand becomes instantly recognizable without need for additional context.

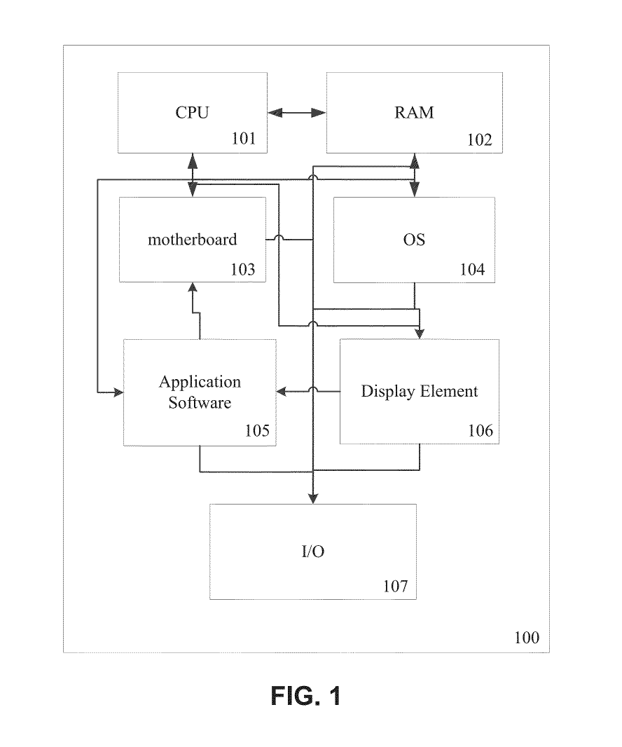

According to an embodiment of the present invention, the system and method is accomplished through the use of one or more computing devices. As shown in FIG. 1, One of ordinary skill in the art would appreciate that a computing device 100 appropriate for use with embodiments of the present application may generally be comprised of one or more of a Central processing Unit (CPU) 101, Random Access Memory (RAM) 102, a storage medium (e.g., hard disk drive, solid state drive, flash memory, cloud storage) 103, an operating system (OS) 104, one or more application software 105, display element 106 and one or more input/output devices/means 107. Examples of computing devices usable with embodiments of the present invention include, but are not limited to, personal computers, smart phones, laptops, mobile computing devices and tablet PCs and servers. One of ordinary skill in the art would understand that any number of computing devices could be used, and embodiments of the present invention are contemplated for use with any computing device.

In an exemplary embodiment according to the present invention, data may be provided to the system, stored by the system and provided by the system to users of the system across local area networks (LANs) (e.g., office networks, home networks) or wide area networks (WANs) (e.g., the Internet, cellular data networks). In accordance with the previous embodiment, the system may receive data from one or more servers or other computing devices communicatively connected across one or more LANs and/or WANs. One of ordinary skill in the art would appreciate that there are numerous manners in which the system could connected and configured to receive and transmit (where applicable) data and embodiments of the present invention are contemplated for use with any configuration.

In general, the system and methods provided herein may be consumed by a user of a computing device whether connected to a network or not. According to an embodiment of the present invention, some of the applications of the present invention may not be accessible when not connected to a network; however a user may be able to compose data offline that will be consumed by the system when the user is later connected to a network.

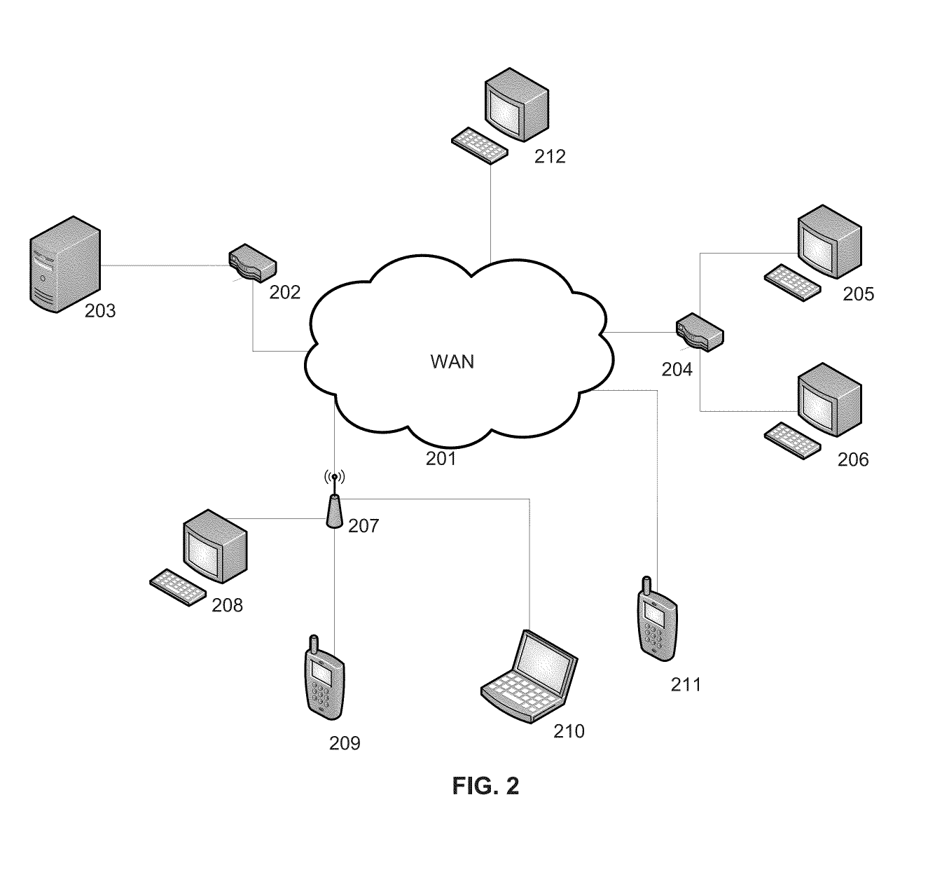

Referring to FIG. 2, a schematic overview of a system in accordance with an embodiment of the present invention is shown. Connection to such networks may be required or desirable for mobile computing device 211 to receive data from any number of sources required for generation of the user interface in accordance with embodiments of the present invention. According to an exemplary embodiment, as shown in FIG. 2, exchange of information through the Network 201 may occur through one or more high speed connections. In some cases, high speed connections may be over-the-air (OTA), passed through networked systems, directly connected to one or more Networks 201 or directed through one or more routers 202. Router(s) 202 are completely optional and other embodiments in accordance with the present invention may or may not utilize one or more routers 202. One of ordinary skill in the art would appreciate that there are numerous ways server 203 may connect to Network 201 for the exchange of information with the mobile computing device 211 or with other computing devices for use with embodiments of the system, and embodiments of the present invention are contemplated for use with any method for connecting to networks for the purpose of exchanging information. Further, while this application refers to high speed connections, embodiments of the present invention may be utilized with connections of any speed.

Components of the system (e.g., mobile computing device 211) may utilize information and data provided by a connection to data server 203 via Network 201 or other network in numerous ways. For instance, a component may connect to the system: i) through a computing device 212 directly connected to the Network 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G) to the Network 201. One of ordinary skill in the art would appreciate that there are numerous ways that a mobile computing device 211 may connect to server 203 via Network 201, and embodiments of the present invention are contemplated for use with any method for connecting to server 203 via Network 201. Furthermore, server 203 could be comprised of a personal computing device, such as a smartphone, acting as a host for other computing devices to connect to.

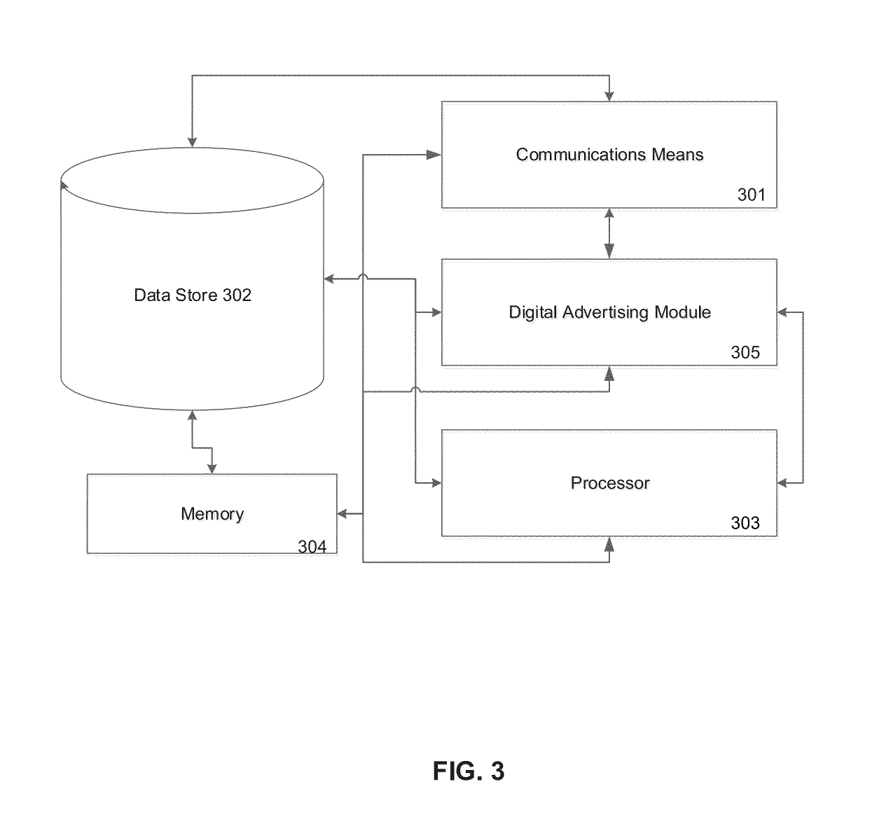

Turning now to FIG. 3, according to an embodiment of the present invention, a system for digital advertising is comprised of one or more communications means 301, one or more data stores 302, a processor 303, memory 304, and a digital advertising module 305. In alternate embodiments, the system may have additional or fewer components. One of ordinary skill in the art would appreciate that the system may be operable with a number of optional components, and embodiments of the present invention are contemplated for use with any such optional component.

According to an embodiment of the present invention, a communications means 301 may be integrated into the system or communicatively connected to the system and configured to handle the transmission and receipt of data and communications. Communications means 301 include, but are not limited to, Ethernet or other wired communications routers/switches/cards, wireless routers/switches/cards, fiber optic communications devices, cellular communications devices, or any combination thereof. One of ordinary skill in the art would appreciate that there are numerous types of communications means 301 that could be utilized with embodiments of the present invention, and embodiments of the present invention are contemplated for use with any type of communications means.

According to an embodiment of the present invention, the digital advertising module is configured to work in conjunction with communications means 301, data stores 302, processor 303 and memory 304 in order to provide the methods of the system described herein.

In a preferred embodiment, the user registers and creates a user profile upon initial use. The user can register through the game's main page with a unique user name. Alternatively, the user is able register and sign-in with a social networking account or use another single sign-on method. The user profile details information about the user's history in connection with the present invention. Profile details information may include, but is not limited to, quizzes that a user has completed and prizes and rewards won by the user. A component of the profile may also include saved quizzes (e.g., links to saved quizzes, stored quizzes, stored partially completed quizzes). It is an aspect of certain embodiments of the present invention that the user may opt to take a quiz at a later date.

In a preferred embodiment of the present invention, a user plays the game when a game icon is displayed over an existing digital advertisement. The digital advertisement can be any form of digital advertisement utilized over the Internet. For example, the digital advertisement can be a video advertisement, a banner advertisement, or text-based advertisement (e.g. sponsored content upon a search inquiry). The icon serves to notify the user that the current advertisement is the subject of a game of the current invention.

According to an embodiment of the present invention, when the user selects the icon, the user is asked whether user desires to take the quiz now or later. If the user selects later, the quiz is stored in the user's profile to allow the user to take the quiz at the user's convenience. In a preferred embodiment the icon also serves to notify the user the amount of reward the user can earn if the user takes and successfully completes the quiz.

In a preferred embodiment, the icon appears over advertisements that are specifically targeted to the user based on demographic profile. Demographic profiles include gender, race, ethnicity, profession, education, hobbies, marital status, Internet usage habits, or any combination thereof. One of ordinary skill in the art would appreciate that there are numerous types of demographic profile information that could be utilized with embodiments of the present invention, and embodiments of the present invention are contemplated for use with any type of demographic profile information. Such targeting improves the efficiency of the present invention. By utilizing demographic profiles so that a user is matched with a product of interest, the marketing efforts of the advertiser are made more efficient.

In a preferred embodiment, once the user selects the icon, a text-based message in a display box appears. The text consists of content pertaining to the brand or the subject-matter of the overlaid advertisement. The content may be, but is not limited to, historical facts about the brand, results of surveys involving the brand, new information concerning the brand, or any tidbit that the advertiser may want to relate to the consumer.

In an embodiment of the invention, the user is presented with a video instead of a text box. The content of the video is of the same type of information that may be communicated through a text-based message. Following the video are the three key questions the user must answer in order to earn a prize.

A component of this invention utilizes technology to identify and target the audience. In certain embodiments, the system can track and identify whether a user has previously been provided the same message or quiz previously. Presenting a user with the same message and quiz creates a redundant user experience, along with yielding a decrease in user engagement or interaction. Therefore, use of identifying technologies by the system, such as, but not limited to, HTTP cookies and sequential messaging based off of said cookie pools, enable the system to provide the user with new content.

According to an embodiment of the present invention, the system is configured to deliver a unique quiz to each user. If a user shares answers of a quiz with a second user, the second users may skip the text and answer the quiz questions without having read the text content or the quiz questions, thereby decreasing overall interaction with the message. In order to combat this, the system may be configured so that a quiz or particular quiz questions are not repeated. Different versions of non-repeat quizzes are envisioned. The quizzes can ask questions in different order and/or ask different questions.

In addition, answer patterns to quizzes could be randomized. For instance, a question on a quiz may have possible answers A, B, C. In a first quiz where the question is presented, the answers may be listed in order (A, B, C). In a second quiz, the question may be presented with the answers listed in a different order (B, A, C). One of ordinary skill in the art would appreciate that there are numerous ways question answers could be randomized, and embodiments of the present invention are contemplated for use with any such randomized answer pattern.

In an embodiment of the current invention, rather than select on an icon that appears over an existing advertisement, the user has other means of taking a quiz. For example, a user can visit a website or operate a mobile/web/software application (“app”).

The difference between clicking an icon and going to a website/operating an app is that by visiting a website or using an app, the user can select a preferred quiz. After signing-in, the user is taken to a user interface menu. The menu consists of different categories of goods and services which the user can select. Once a category is selected, a list of various brand name products and services appear. In an embodiment, a description of each product is provided. In another embodiment, the reward amount is displayed. By selecting a brand, a text-based message appears pertaining to the selected brand. After reading the text, the user may opt to take the quiz by selecting an icon. The user also has the option of taking the quiz at a later date.

The quiz can be of various formats. In the preferred embodiment, the quiz consists of question-answer format. Other embodiments include selecting a true or false statement among those presented or a multiple choice format. In a preferred embodiment, the quiz consists of three questions or statements. Embodiments that utilize additional or fewer questions are also envisioned.

While taking the quiz, there is flexibility so that the user is able to navigate back to the content while answering the questions. Such ability will engage the user in a stress-free atmosphere without any concern for whether the text-based information is retained. The goal of the invention is to promote interaction between the user and a brand product. By allowing the user to navigate back and forth, the interaction and relationship between the user and the brand product increases.

Users are rewarded upon correctly answering all the questions. The reward serves to incentivize users to read the text and answers the questions. Reading the text informs the user about the product, thereby enhancing brand awareness.

If a user does not correctly answer all the quiz questions, the user has the ability to return to the quiz at a later time. Permitting the user to take the quiz at a later time rather than instantly is preferable so that the user has a second complete engagement with the brand.

Once a user correctly answers all questions, a reward is earned. In the preferred embodiment, the user earns monetary currency. For example, for each perfectly-scored quiz, the user can earn from $0.10-$0.25. Once the user earns a certain threshold amount, for example, $20.00, the monetary award is distributed to the user via a money transfer service, such as PayPal. Payments can be made to the user on a monthly basis.

In an embodiment of the invention, users can earn money for charities. By registering under the name of a preferred charity, the user donates money to a select charity with each earnings.

In an embodiment, once a user registers, the user can create a network consisting of other users. Creation of this network can be accomplished through various means. For example, a user can add other users who have registered through the website. Users can also be added by sending invitations to potential users through social networking sites. User networks may also be used by the system to limit quiz and message repetition to ensure engagement amongst users is complimentary and remains engaging.

Creation of a network provides an additional means for the user to earn monetary reward. The primary user can add other users to his or her network. These other users are considered to have a special first status indicator (i.e., “Ruby” status) and are one degree away from the primary user. Any user who does not have Ruby status but is connected to a user with Ruby status is considered to have a second status indicator (i.e., “Emerald” status) and is two degrees away from the primary user. This hierarchy may continue with even further degrees of connection. Whenever a user in a network earns money by taking a quiz, other users in that network will earn a reward equivalent to a percentage of the primary user's earnings. The amount of reward earned is dependent on the user's status within the network.

In an embodiment of the invention, users can compete with one another in battle mode. In battle mode, users compete to correctly complete a quiz in the fastest time. In one version, the winner of battle mode earns the displayed amount. In another version, the winner of battle mode earns the sum of both users' participation. In another version the winner and user will earn different proportions of the sum total.

Data surrounding users who have taken the quiz can be valuable to advertisers. Advertisers often use demographics, behavioral & psychographic data in order to deliver targeted advertisements to specific/qualifying users. The pairing of user, quiz & brand yields crucial & actionable information that advertisers can leverage to build out robust audiences profiles, model audiences based on said profiles and execute targeted advertising campaign based on such data. This information can be in the form of surveys according to various demographic parameters such as profession, age, and gender—along with more robust data sets such as brand affinity, browsing behaviors and psychographics. Additional parameters can be the frequency & amount of tests taken, and the distribution of perfect and non-perfect scores. Advertisers can then pay to access user surveys.

Text displayed in the text box will be submitted by advertisers. This will allow advertisers to control the message conveyed to users and to synchronize an existing advertising campaign over various types of forums. As an illustrative example, if a car manufacturer wants to convey a message about the fuel efficiency of a new vehicle, the manufacturer can convey this message through billboards, television, digital ads, and the current invention. The utility of the current invention solves for the drawbacks with the other advertising forums, namely the passive interaction with the user. However, if the user is incentivized to pay attention to the advertising, the message of the advertising campaign is better conveyed.

In order for advertisers to provide their own text, an advertiser intake form will be provided. The intake form will ask for the company name, the brand, a trademarked slogan (or any other unique identifiers), and product information.

The intake form will also have an option prize section. In addition to providing their own text, advertisers can also supply their own prizes in addition to the award of the current invention. At the conclusion of the quiz, advertisers may be given a chance to provide their own discounts, coupons, rebates, etc. In an embodiment, advertisers can offer these rewards by providing the users with a URL link to their own rewards page on their website.

In an embodiment of the invention, users are able to provide their own text, questions and answers for a brand of their choosing. Such user content can be distributed to other users. As further incentive for user interaction with a brand, a reward may be disturbed for the creation of user content.

### EXEMPLARY EMBODIMENT

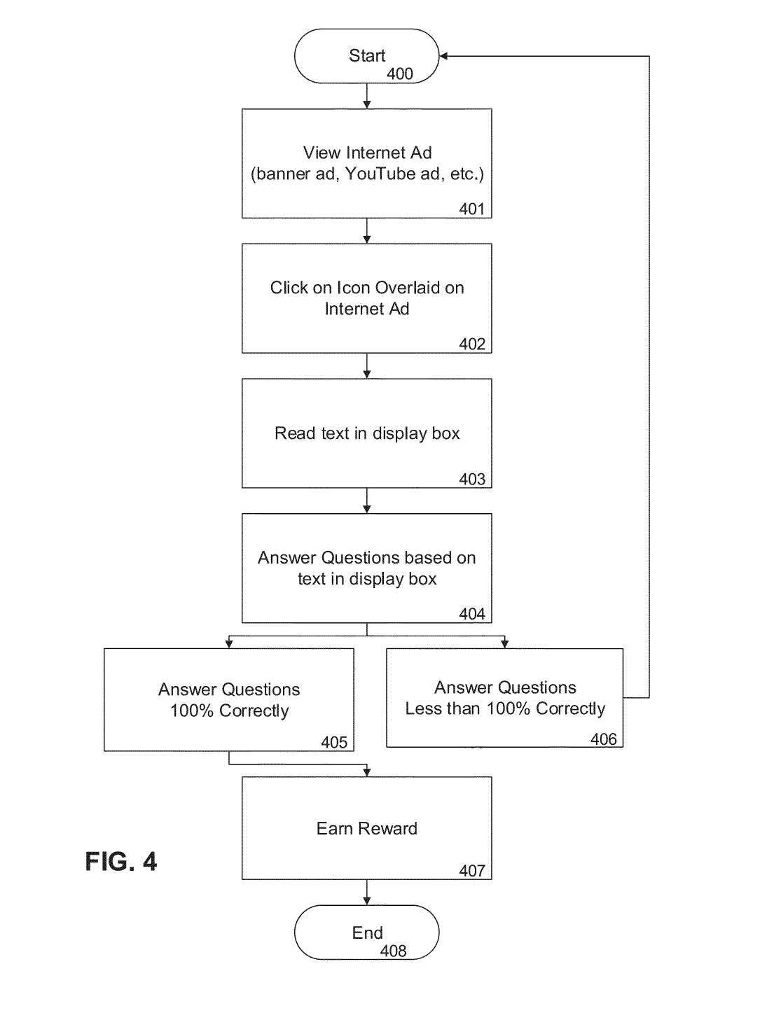

According to an embodiment of the present invention, below is an exemplary method for digital advertising method, as shown in FIG. 4.

At step 400, the method begins with the system being activated. Initial activation of the system begins with the user registering and creating profile. Subsequent activation begins whenever the user signs-in to the invention's main page. In the preferred embodiment, the registering device may be a computer or any other computing device capably equipped with a display element and means to receive user input. At step 401, the user views an Internet advertisement. The Internet advertisement can take any form, whether text, picture, or video.

At step 402, the registering process displays an icon over the advertisement the user was viewing. The user is now required to click on the icon. In a preferred embodiment, the user is given the option to take the quiz at the moment or at a later date. If the user elects to take the quiz at a later date, the quiz is stored in the user's profile.

At step 403, a text box appears when the user is ready to take the quiz. In another embodiment, the text box may consist of a video. The contents of the text box relate to the brand product of the advertisement viewed by the user at step 401. At this step, the user reads the text, which will serve as the basis for the forthcoming quiz.

At step 404, the user is asked questions based on the text of step 403. The questions can be of many types. In a preferred embodiment, there will be three multiple choice questions. In a preferred embodiment, the user is permitted to navigate back to the text display and then navigate forward to return to the quiz screen.

After taking the quiz, there are two possibilities: the user proceeds to step 405 if all the questions are answered correctly or the user proceeds to step 406 if the some questions were mistakenly answered. If the user is at step 406, the user has the option to begin the quiz again. In a preferred embodiment, the user must wait a certain time before commencing the quiz again. It is preferable for the user to partake in advertising method at separate sessions rather than continue the same session. Repeated exposure to the brand through the quiz will create a stronger impression and further raise brand awareness than a single interaction.

At step 407, a user who has correctly answered the quiz questions earns a prize. In a preferred embodiment, the user will earn a monetary reward. At step 408, the process terminates.

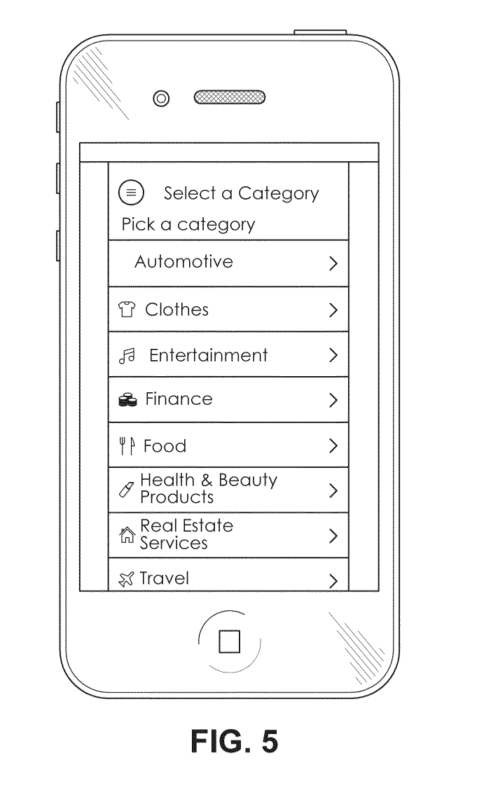

Turning now to FIG. 5, an exemplary embodiment of a graphical user interface on a mobile device in accordance with an embodiment of the present invention. In an embodiment, the user can log-in via a mobile application. FIG. 5 shows an illustrative example of an interactive graphical user interface which displays a menu of the different categories of goods and services from which the user can select. Each category will open to another menu of various goods and services arranged by brands so that a user may select a brand with which to interact. One of ordinary skill in the art would appreciate any suitably configured graphical user interface could be used with embodiments of the present invention, and embodiments of the present invention are contemplated for use with any such graphical user interface.

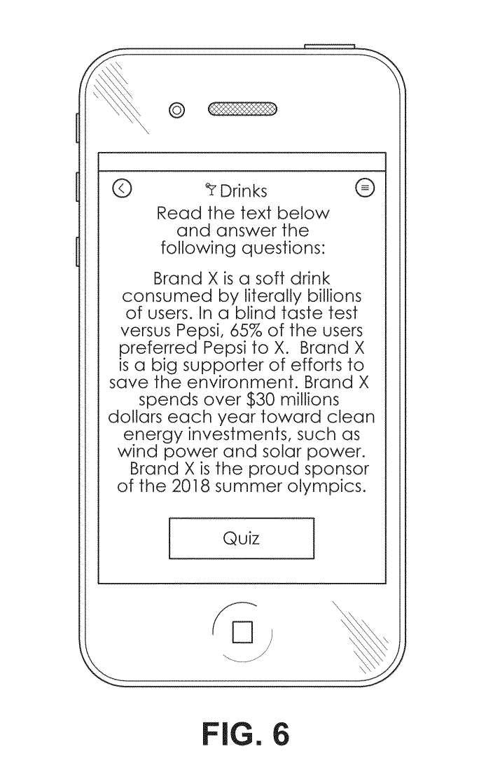

Turning now to FIG. 6, an exemplary embodiment of a graphical user interface on a mobile device in accordance with an embodiment of the present invention. After the user selects a brand, text pertaining to the brand is presented. Here is an illustrative example of a user interface after a brand-name drink is selected. Following the text is an interactive button allowing the user to proceed to take the quiz. In an embodiment, selecting this button will then present the user with an option to take the quiz at a later date. One of ordinary skill in the art would appreciate any suitably configured graphical user interface could be used with embodiments of the present invention, and embodiments of the present invention are contemplated for use with any such graphical user interface.

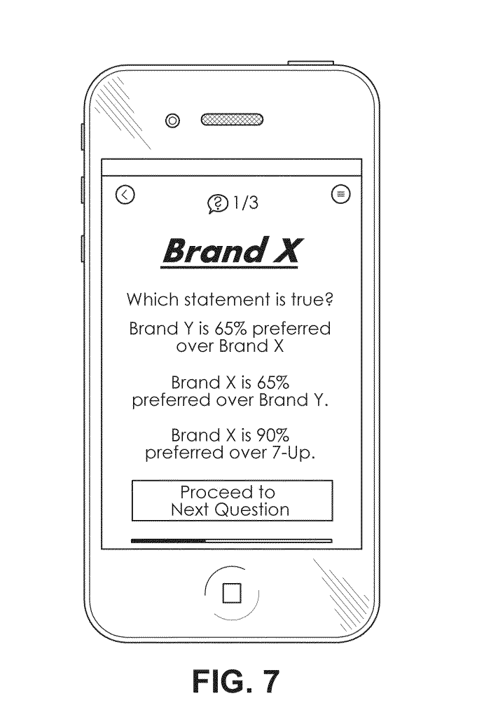

Turning now FIG. 7, an exemplary embodiment of a graphical user interface on a mobile device in accordance with an embodiment of the present invention. Here is an illustrative example of a quiz question. In FIG. 6, the user was presented with text pertaining to drink Brand X. In this figure, the user is asked which of the following statements is “true”. If the user cannot recall, the user has capability to return to the text screen. One of ordinary skill in the art would appreciate any suitably configured graphical user interface could be used with embodiments of the present invention, and embodiments of the present invention are contemplated for use with any such graphical user interface.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

According to an embodiment of the present invention, a data store may be comprised of one or more of a database, file storage system, relational data storage system or any other data system or structure configured to store data, preferably in a relational manner. In a preferred embodiment of the present invention, the data store may be a relational database, working in conjunction with a relational database management system (RDBMS) for receiving, processing and storing data. In the preferred embodiment, the data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, HTML, Perl, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present invention are contemplated for use with any language.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A system for digital advertising, the system comprising:
a digital advertising module, comprising computer-executable code stored in non-volatile memory,
a processor,
a communications means, and
a display element;
wherein the digital advertising module, the processor, and the communications means are operably connected and configured to:
display a logo over an existing digital advertisement over the Internet via the display element;
enable a text-based message display when the logo is clicked by a user via a user interface, wherein the text-based message pertains to a content of the existing digital advertisement;
present one or more questions based on the content of the text-based message display in the form of a quiz to the user;
request the user to select a correct answer among multiple statements provided;
permit the user to select an answer via a user interface; and
reward the user if all answers were correctly selected.

2. The digital advertising module of claim 1 further configured to:
select the existing digital advertisement wherein the logo is overlaid;
provide a text-based message relevant to the existing digital advertisement;
provide a quiz based on the text-based message, wherein the quiz is randomized to ensure user does not receive duplicate quiz; and
process the reward allocation.

3. The system of claim 1, wherein said user interface is a graphical user interface provided on a capacitive touch screen of a desktop computer, tablet computer, or mobile device.

4. A method and computer program for digital advertising, the method comprising the steps of:
displaying a logo imbedded within an existing digital advertisement over the Internet;
enabling a text-based message display box upon clicking of the logo by a user via a user interface, wherein the text-based message pertains to a content of the existing digital advertisement;
presenting one or more questions based on the content of the text-based message in the form of a quiz to a user via the text-based message display box;
requesting the user to select a correct answer among multiple statements provided;
permitting user to select an answer via a user interface; and
rewarding the user if all answers were correctly selected.

5. The method of claim 4 wherein the digital advertising is an image-based advertisement.

6. The method of claim 4 wherein the digital advertising is a text-based advertisement.

7. The method of claim 4 wherein the user is monetarily rewarded with real currency.

8. The method of claim 4, further comprising the step of operating a quiz website.

9. The method of claim 8 comprising:
registering users to the website through the user's option of website's own registration, a social media site, or user's email; and
enabling users to connect to other individuals thereby creating a network, wherein the individuals in user's network can earn rewards for the user by participating in the computer program.

10. The method of claim 10 further comprising the step of rewarding the users and individuals based on their relationship within the network.

11. An system for an Internet advertisement website, comprising:
an advertisement website and at least one host server computer hosting the website and providing Internet access thereto, the website having sufficient software to provide:
an advertisement module, comprising computer-executable code stored in non-volatile memory,
a processor,
a communications means, and
wherein the advertisement module, the processor, and the communications means are operably connected and are configured to:
register users at the user's option through the website's own registration, a social media site, or user's email;
present the user with a list of categories wherein the user selects a category through a user interface;
offer a list of goods and services appropriate within each category organized by brand name from which the user selects a good or service;
display text-based content relevant to selected good or service;
allow user to take a quiz based on the content of the text displayed via a user interface;
randomize the quiz to decrease chances of receiving duplicate quiz;
reward the user if user correctly answers quiz question; and
offer a list of goods and services appropriate within each category organized by brand name from which the user selects a good or service.

12. A method of advertisement website, comprising:
registering users at the user's option of the website's own registration, a social media site, or user's email;
presenting the user with a list of categories wherein the user selects a category through a user interface;
offering a list of goods and services appropriate within each category organized by brand name from which the user selects a good or service;
displaying text-based content relevant to selected good or service;
allowing the user to take a quiz based on the content of the text displayed via a user interface;
rewarding the user if user correctly answers questions; and
maintaining data of user's result history.

13. The method of claim 11 wherein the quizzes presented to users are based on data of demographic profiling.

14. The method of claim 11 wherein a user can navigate back to text-based content while taking the quiz.

15. The method of claim 11 wherein the reward is in the form of monetary currency received through an online money transfer.

16. The data of user's result history of claim 11, wherein such data is commoditized for sale to interested parties.
